(19) United States
(12) Patent Application Publication
(10) Pub. No.: US 2016/0377898 A1
(43) Pub. Date: Dec. 29, 2016

(54) IPS IN-CELL TOUCH DISPLAY PANEL AND MANUFACTURING METHOD THEREOF

(71) Applicant: Shenzhen China Star Optoelectronics Technology Co. Ltd., Shenzhen City (CN)

(72) Inventor: Xiangyang Xu, Shenzhen City (CN)

(21) Appl. No.: 14/778,078

(22) PCT Filed: Jul. 23, 2015
(86) PCT No.: PCT/CN2015/084873

§ 371 Date: Sep. 17, 2015

(30) Foreign Application Priority Data
Jun. 29, 2015 (CN) 201510368558.X

(51) Int. Cl. G02F 1/1333; G02F 1/1343; G02F 1/1339; G02F 1/1368; G02F 1/1337; G06F 3/041; G02F 1/1335

(52) U.S. Cl. CPC G02F 1/13338; G06F 3/0412; G02F 1/134363; G02F 1/133516; G02F 1/133512; G02F 1/1368; G02F 1/134309; G02F 1/13439; G02F 1/1337; G02F 1/13394; G06F 2203/04103; G06F 2203/04107; G02F 2001/133519

(57) ABSTRACT

The present invention provides an IPS in-cell touch display panel and a manufacturing method thereof. The IPS in-cell touch display panel includes insulating photoresist blocks (6) arranged at intersections between touch transmission electrodes (4) and touch receiving electrodes (5) for insulation. The method applies a grey-tone mask and etching operation to form touch transmission electrodes (4) and preserves portions of an organic photoresist that correspond to intersections in perpendicularity between the touch transmission electrodes (4) and touch receiving electrodes (5) to form insulating photoresist blocks (6) to allow insulation to be achieved between the touch transmission electrodes (4) and the touch receiving electrodes (5) with the insulating photoresist blocks (6) so that coating and masking and etching operations specifically for making an insulation layer can be eliminated to thereby simplify the manufacturing operation of a touch display panel, reduce the manufacturing cost, and increase the manufacturing efficiency; and in addition, the touch transmission electrodes (4) and the touch receiving electrodes (5) provide an effect of electromagnetic shielding to capacitance of the liquid crystal layer so that there is no need to specifically form a protection electrode.

### BACKGROUND OF THE INVENTION

1. Field of the Invention

The present invention relates to the field of display technology, and in particular to an in-plane switching (IPS) in-cell touch display panel and a manufacturing method thereof.

2. The Related Arts

With the rapid process of the display technology, touch display panels have been widely accepted and used by people. For example, intelligent phones and tablet computers both involve the use of touch display pane. The touch display panel is formed by applying the embedding touch technology to combine a touch panel and a liquid crystal display panel with each other as a unit with the functionality of the touch panel embedded in the liquid crystal display panel to make the liquid crystal display panel to simultaneously possess the functions of displaying and touch control/input.

The liquid crystal display panels are generally made up of a color filter (CF) substrate, a thin-film transistor (TFT) array substrate, and a liquid crystal layer interposed between the two substrates, of which the principle of operation is to control liquid crystal molecule to rotate by applying a driving voltage to the two glass substrates in order to refract out light from a backlight module to generate an image. According to the different ways of alignment of the liquid crystal, the liquid crystal display panels of the main stream market can be classified in several types: vertical alignment (VA), twisted nematic (TN) or super twisted nematic (STN), in-plane switching (IPS), and fringe field switching (FFS).

In the IPS liquid crystal display panel, the liquid crystal molecule are aligned in parallel with substrate surfaces and the rotation of the liquid crystal molecules is controlled by applying a lateral electrical field to the liquid crystal layer. As shown in FIG. 1, a conventional IPS liquid crystal display panel generally comprises a TFT substrate 100 and a CF substrate 200 that are arranged opposite to each other and a liquid crystal layer 300 interposed between the two. The TFT substrate 100 comprises: a lower backing plate 110, a gate terminal 121, a scan line 122, a gate insulation layer 130, a semiconductor layer 140, source/drain terminals 151, a data line 152, an indium tin oxide (ITO) pixel electrode 160, an insulation protection layer 170, a comb-like ITO common electrode 180, and a lower alignment film 190. The CF substrate 200 comprises: an upper backing plate 210, a color filter photoresist 220, a back matrix 230, a photo spacer 240, and an upper alignment film 250. To provide electromagnetic protection to the conventional IPS liquid crystal display panel. A layer of ITO transparent electrode 260 is arranged on the entirety of a surface of the upper backing plate 210 of the CF substrate 200 that is distant from the liquid crystal layer 3.

The touch display panels can be classified, according to techniques of detection applied, four types, which are resistive type, capacitive type, optical type, and acoustic wave type. The main stream of the touch technology is the capacitive type, which is further divided into self-capacitance type and mutual capacitance type. The capacitive touch display panels that are currently available in the market are primarily the mutual capacitance type. An advantage of the mutual capacitance type is the capability of multiple point touch control. The touch display panels can be further classified, according to the structures thereof, into on-cell type, in-cell type, and external mounting type, among which the in-cell type possess advantages of low cost, being ultra-thin, and narrowed frame and are generally applied in high-end touch products. However, due to factors, such as higher technical difficulty and being susceptible to signal interference, the sensitivity of the in-cell touch control is generally poor. The touch display panels that are most widely used in the current market are the external mounting type. Advantages of the external mounting type include high sensitivity and fast response speed, but there are also disadvantages including high cost and limitation on product thinning. The on-cell types possesses the advantages of both the external mounting type and the in-cell type and thus has increased sensitivity and allows for reduction of panel thickness. However, a manufacturing process of an on-cell touch display panel allows a transparent electrode of indium tin oxide (ITO) that is provided for making a touch control circuit to be coated on a panel surface after boxing of liquid crystal. ITO has a limited annealing temperature so that the impedance can hardly be lowered, leading to a constrain to the increase of touch sensitivity.

### SUMMARY OF THE INVENTION

An object of the present invention is to provide an in-plane switching (IPS) in-cell touch display panel, which has a simple manufacturing operation, a low manufacturing cost, and a high manufacturing efficiency.

Another object of the present invention is to provide a manufacturing method of an IPS in-cell touch display panel, which simplifies a manufacturing operation of a touch display panel, reduces a manufacturing cost, and increases a manufacturing efficiency.

To achieve the above objects, the present invention provides an IPS in-cell touch display panel, which comprises a thin-film transistor (TFT) array substrate, a color filter (CF) substrate opposite to the TFT array substrate, a liquid crystal layer interposed between the TFT array substrate and the CF substrate, a plurality of touch transmission electrodes parallel to each other and arranged on a surface of the CF substrate that is adjacent to the liquid crystal layer, and a plurality of touch receiving electrodes parallel to each other and perpendicularly intersecting the touch transmission electrodes in space, insulation being achieved by a plurality of insulating photoresist blocks arranged at locations respectively corresponding to the intersections of the touch transmission electrodes and the touch receiving electrodes to separate the two from each other;

the CF substrate comprising a backing plate, the plurality of touch transmission electrodes being arranged on a surface of the backing plate that is adjacent to the liquid crystal layer, the plurality of touch receiving electrodes being arranged to perpendicularly intersect the touch transmission electrodes in space through the insulating photoresist blocks therebetween.

The touch transmission electrodes and the touch receiving electrodes are formed of a material of indium tin oxide (ITO).

The touch transmission electrodes and the touch receiving electrodes have a thickness of 400-1000 Å.

The CF substrate further comprises a color filter photoresist arranged on the plurality of touch receiving electrodes and the backing plate, a black matrix separating and isolating the color filter photoresist, a photo spacer arranged on the black matrix, and an alignment film covering the color filter photoresist, the black matrix, and the photo spacer.

The present invention also provide an IPS in-cell touch display panel, which comprises a TFT array substrate, a CF substrate opposite to the TFT array substrate, a liquid crystal layer interposed between the TFT array substrate and the CF substrate, a plurality of touch transmission electrodes parallel to each other and arranged on a surface of the CF substrate that is adjacent to the liquid crystal layer, and a plurality of touch receiving electrodes parallel to each other and perpendicularly intersecting the touch transmission electrodes in space, insulation being achieved by a plurality of insulating photoresist blocks arranged at locations respectively corresponding to the intersections of the touch transmission electrodes and the touch receiving electrodes to separate the two from each other;

the CF substrate comprising a backing plate, the plurality of touch transmission electrodes being arranged on a surface of the backing plate that is adjacent to the liquid crystal layer, the plurality of touch receiving electrodes being arranged to perpendicularly intersect the touch transmission electrodes in space through the insulating photoresist blocks therebetween;

wherein the touch transmission electrodes and the touch receiving electrodes are formed of a material of ITO;

wherein the touch transmission electrodes and the touch receiving electrodes have a thickness of 400-1000 Å; and

wherein the CF substrate further comprises a color filter photoresist arranged on the plurality of touch receiving electrodes and the backing plate, a black matrix separating and isolating the color filter photoresist, a photo spacer arranged on the black matrix, and an alignment film covering the color filter photoresist, the black matrix, and the photo spacer.

The present invention further provides a manufacturing method of an IPS in-cell touch display panel, which comprises the following steps:

(1) providing a backing plate, coating a transparent conductive layer on a surface of the backing plate, applying a grey-tone mask and etching operation to form a plurality of touch transmission electrodes parallel to each other and a plurality of independent insulating photoresist blocks on each of the touch transmission electrodes;

(2) subjecting the touch transmission electrodes to high temperature annealing;

(3) further coating a transparent conductive layer and applying a regular masking and etching operation to form a plurality of touch receiving electrodes that perpendicularly intersects the touch transmission electrodes in space through the insulating photoresist blocks;

(4) applying a regular masking and etching operation to form, in sequence, a black matrix, a color filter photoresist, and a photo spacer on the touch receiving electrodes and the backing plate,

wherein the black matrix separates and isolates the color filter photoresist and the photo spacer is arranged on the black matrix;

(5) coating an alignment solution on the color filter photoresist, the black matrix, and the photo spacer to form an alignment film, thereby forming a CF substrate; and

(6) providing a TFT array substrate and laminating the TFT array substrate and the CF substrate together in such a way that the touch receiving electrodes face the TFT array substrate and filling liquid crystal between the TFT array substrate and the CF substrate to form a liquid crystal layer.

Step (1) comprises:

(11) coating a layer of organic photoresist on the transparent conductive layer;

(12) applying a grey-tone mask to subject an area of the organic photoresist corresponding to a spatial interval between every two adjacent ones of the touch transmission electrodes to full exposure and an area of the organic photoresist corresponding to each of the insulating photoresist blocks not subjected to exposure; and subjecting an area of the organic photoresist corresponding a location of each of the touch transmission electrodes between every two adjacent ones of the insulating photoresist blocks to partial exposure; and then conducting development;

(13) subjecting the transparent conductive layer to etching with the organic photoresist as a shielding layer to form a plurality of touch transmission electrodes parallel to each other; and

(14) subjecting the organic photoresist to ashing treatment to remove the partial exposure portions of the organic photoresist with unexposed portions of the organic photoresist left so as to form a plurality of independent insulating photoresist blocks on each of the touch transmission electrodes.

In step (11), the transparent conductive layer is formed of a material of ITO and has a thickness of 400-1000 Å and the organic photoresist has a thickness of 4000-20000 Å.

In step (3), the transparent conductive layer is formed of a material of ITO and has a thickness of 400-1000 Å.

In step (2), an atmosphere for the high temperature annealing is nitrogen or dry air, a temperature of the high temperature annealing being 250° C., a period of time for the annealing being 30 minutes.

The backing plate is a glass plate.

The efficacy of the present invention is that the present invention provides an IPS in-cell touch display panel, which comprises insulating photoresist blocks arranged at the intersections of touch transmission electrodes and touch receiving electrodes to separate the two from each other for insulation so that the manufacturing operation is simplified, the manufacturing cost is reduced, and the manufacturing efficiency is increased. Further, the touch transmission electrodes and the touch receiving electrodes provide an effect of electromagnetic shielding for capacitance of a liquid crystal layer. The present invention also provides a manufacturing method of an IPS in-cell touch display panel that applies a grey-tone mask and etching operation to form touch transmission electrodes and preserves portions of an organic photoresist that correspond to intersections in perpendicularity between the touch transmission electrodes and touch receiving electrodes to form insulating photoresist blocks to allow insulation to be achieved between the touch transmission electrodes and the touch receiving electrodes with the insulating photoresist blocks so that coating and masking and etching operations specifically for making an insulation layer can be eliminated to thereby simplify the manufacturing operation of a touch display panel, reduce the manufacturing cost, and increase the manufacturing efficiency; and in addition, the touch transmission electrodes and the touch receiving electrodes provide an effect of electromagnetic shielding to capacitance of the liquid crystal layer so that there is no need to specifically form a protection electrode on a surface of the CF substrate that is distant from the liquid crystal layer to thereby further simplify the manufacturing operation of the touch display panel, reduce the manufacturing cost, and increase the manufacturing efficiency.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a cross-sectional view of a conventional in-plane switching (IPS) liquid crystal display panel;

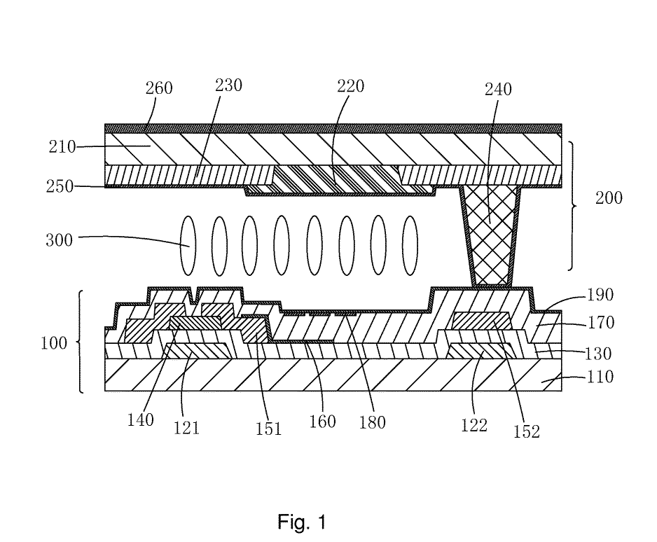

FIG. 2 is a cross-sectional view showing an IPS in-cell touch display panel according to the present invention;

FIG. 3 is a bottom view of touch transmission electrodes of the IPS in-cell touch display panel according to the present invention;

FIG. 4 is a bottom view of touch receiving electrodes and the touch transmission electrodes of the IPS in-cell touch display panel according to the present invention;

FIG. 5 is a flow chart illustrating a manufacturing method of an IPS in-cell touch display panel according to the present invention;

FIG. 6 is a schematic view illustrating a first step of the manufacturing method of the IPS in-cell touch display panel according to the present invention; and

FIGS. 7-10 illustrate manufacturing processes of the sites corresponding to sections A-A and B-B of FIG. 6.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

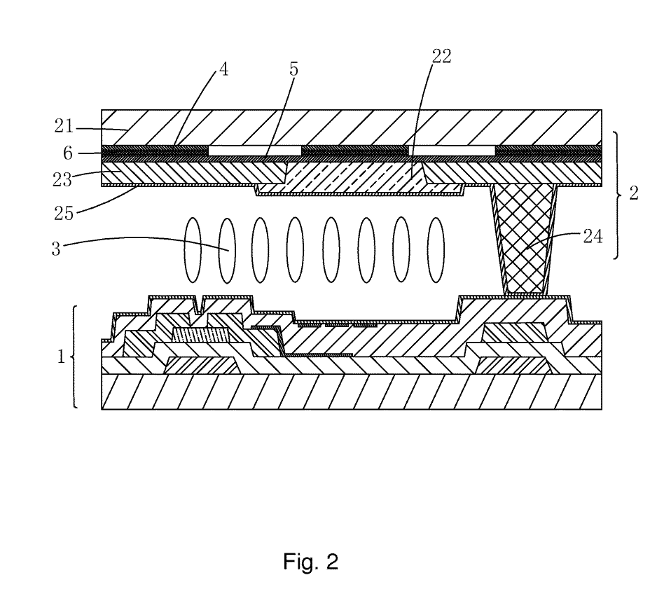

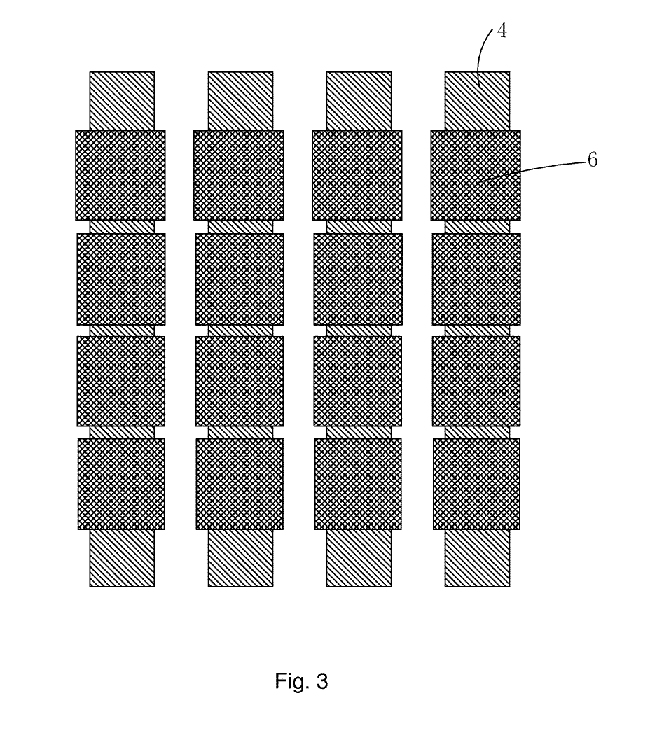

Referring collectively to FIGS. 2-4, firstly, the present invention provides an in-plane switching (IPS) in-cell touch display panel, which comprises a thin-film transistor (TFT) array substrate 1, a color filter (CF) substrate 2 opposite to the TFT array substrate 1, a liquid crystal layer 3 interposed between the TFT array substrate 1 and the CF substrate 2, a plurality of touch transmission electrodes 4 parallel to each other and arranged on a surface of the CF substrate 2 that is adjacent to the liquid crystal layer 3, and a plurality of touch receiving electrodes 5 parallel to each other and perpendicularly intersecting the touch transmission electrodes 4 in space. Insulation is achieved by a plurality of insulating photoresist blocks 6 arranged at locations respectively corresponding to the intersections of the touch transmission electrodes 4 and the touch receiving electrodes 5 to separate the two from each other.

The TFT array substrate 1 comprises a backing plate, a gate terminal, a scan line, a gate insulation layer, a semiconductor layer, source/drain terminals, a data line, a pixel electrode, an insulation protection layer, a comb-like common electrode, and an alignment film and is similar to a TFT array substrate that is involved in a known IPS liquid crystal display panel so that no detail will be provided herein.

The CF substrate 2 comprises a backing plate 21. The plurality of touch transmission electrodes 4 is arranged on a surface of the backing plate 21 that is adjacent to the liquid crystal layer 3. The plurality of touch receiving electrodes 5 is arranged to perpendicularly intersect the touch transmission electrodes 4 in space through the insulating photoresist blocks 6 therebetween. The CF substrate 2 further comprises a color filter photoresist 22 arranged on the plurality of touch receiving electrodes 5 and the backing plate 21, a black matrix 23 separating and isolating the color filter photoresist 22, a photo spacer 24 arranged on the black matrix 23, and an alignment film 25 covering the color filter photoresist 22, the black matrix 23, and the photo spacer 24.

Specifically, the backing plate 21 is a glass plate.

The touch transmission electrodes 4 and the touch receiving electrodes 5 are each formed of a material of indium tin oxide (ITO) and have a thickness of 400-1000 Å.

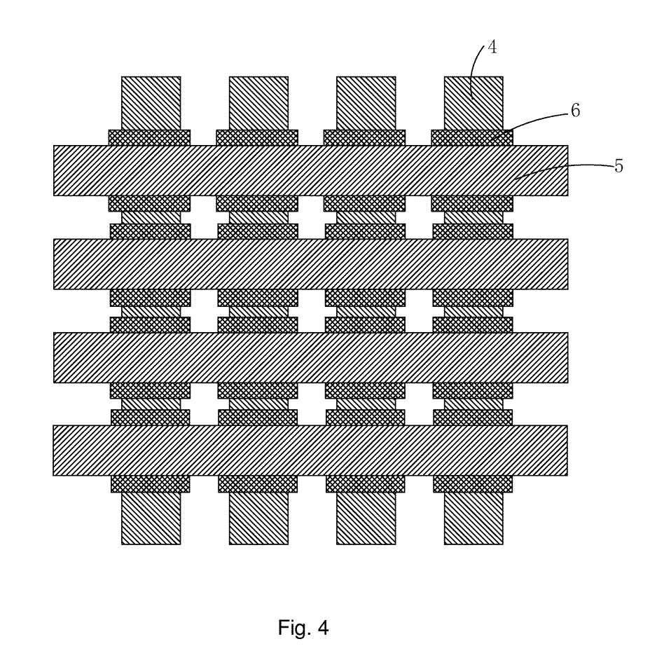

As shown in FIG. 4, the present invention provides an IPS in-cell touch display panel, which comprises insulating photoresist blocks 6 arranged at the intersections of touch transmission electrodes 4 and touch receiving electrodes 5 to separate the two from each other for insulation so that the manufacturing operation is simplified, the manufacturing cost is reduced, and the manufacturing efficiency is increased. Further, the touch transmission electrodes 4 and the touch receiving electrodes 5 provide an effect of electromagnetic shielding for capacitance of a liquid crystal layer 3.

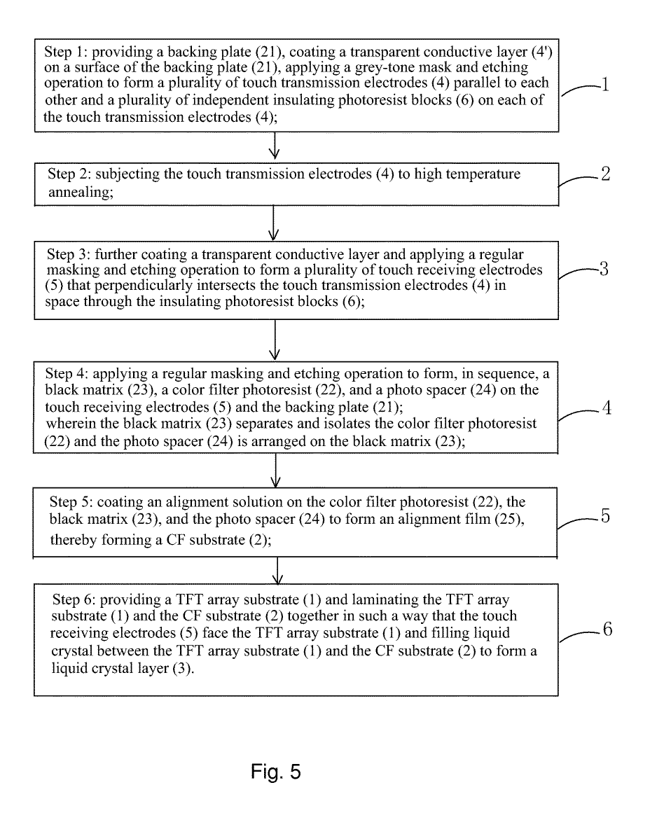

Referring to FIG. 5, the present invention further provides a manufacturing method of an IPS in-cell touch display panel, which comprises the following steps:

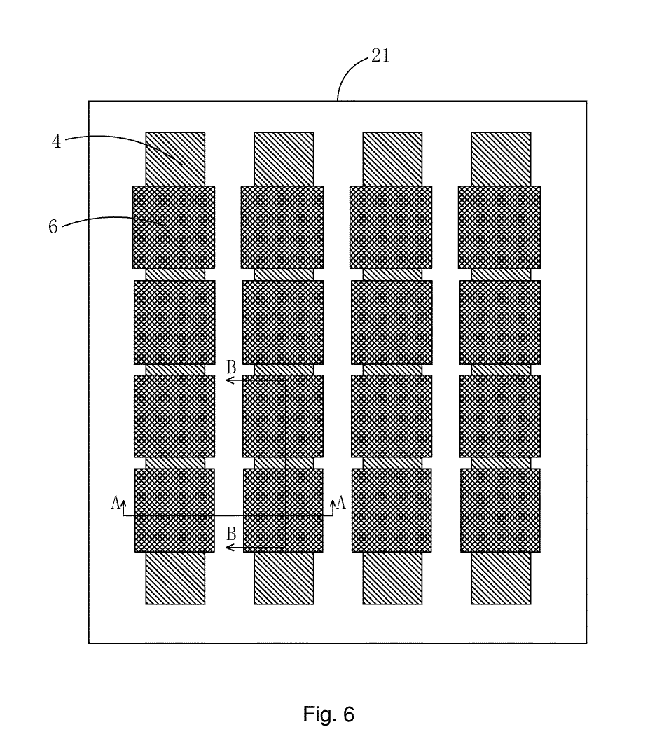

Step 1: referring to FIGS. 2, 6, and 7-10, providing a backing plate 21, coating a transparent conductive layer 4′ on a surface of the backing plate 21, applying a grey-tone mask and etching operation to form a plurality of touch transmission electrodes 4 parallel to each other and a plurality of independent insulating photoresist blocks 6 on each of the touch transmission electrodes 4.

The backing plate 21 is preferably a glass plate.

Specifically, Step 1 comprises:

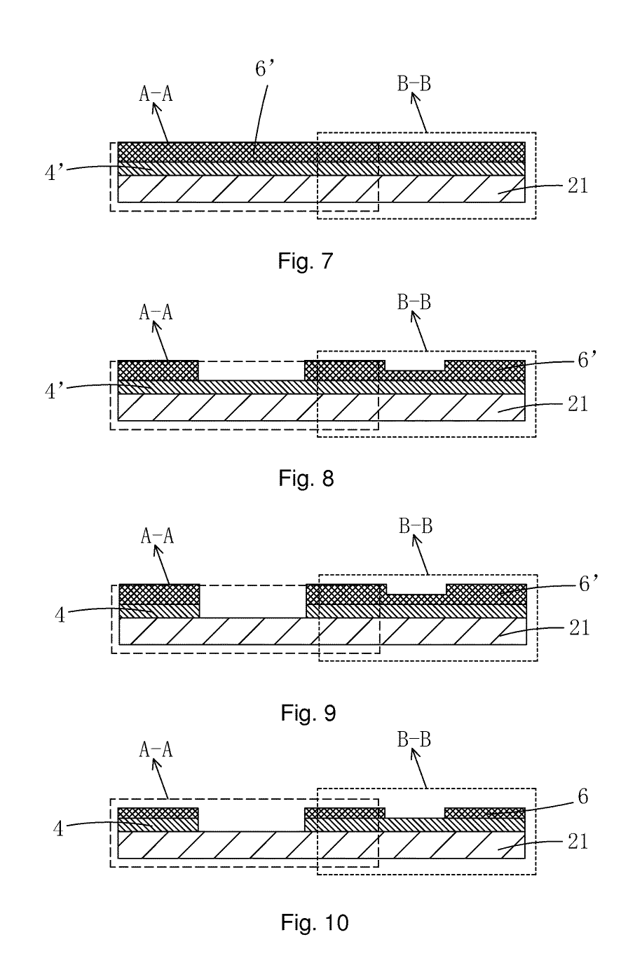

Step 11: as shown in FIG. 7, coating a layer of organic photoresist 6′ on the transparent conductive layer 4′.

Further, the transparent conductive layer 4′ is formed of a material of ITO and has a thickness of 400-1000 Å; the organic photoresist 6′ has a thickness of 4000-20000 Å.

Step 12: as shown in FIG. 8, applying a grey-tone mask to subject an area of the organic photoresist 6′ corresponding to a spatial interval between every two adjacent ones of the touch transmission electrodes 4 to full exposure and an area of the organic photoresist 6′ corresponding to each of the insulating photoresist blocks 6 not subjected to exposure; and subjecting an area of the organic photoresist 6′ corresponding a location of each of the touch transmission electrodes 4 between every two adjacent ones of the insulating photoresist blocks 6 to partial exposure; and then conducting development.

Step 13: as shown in FIG. 9, subjecting the transparent conductive layer 4′ to etching with the organic photoresist 6′ as a shielding layer to form a plurality of touch transmission electrodes 4 parallel to each other.

Step 14: as shown in FIG. 10, subjecting the organic photoresist 6′ to ashing treatment to remove the partial exposure portions of the organic photoresist 6′ with unexposed portions of the organic photoresist 6′ left so as to form a plurality of independent insulating photoresist blocks 6 on each of the touch transmission electrodes 4.

Step 2: subjecting the touch transmission electrodes 4 to high temperature annealing.

Further, an atmosphere for the high temperature annealing is nitrogen or dry air. The temperature of the high temperature annealing is 250° C. and the time for annealing is 30 minutes.

Step 3: referring to FIGS. 2 and 4, further coating a transparent conductive layer and applying a regular masking and etching operation to form a plurality of touch receiving electrodes 5 that perpendicularly intersects the touch transmission electrodes 4 in space through the insulating photoresist blocks 6.

Further, the transparent conductive layer of Step 3 is formed of a material of ITO and has a thickness of 400-1000 Å.

Step 4: referring to FIG. 2, applying a regular masking and etching operation to form, in sequence, a black matrix 23, a color filter photoresist 22, and a photo spacer 24 on the touch receiving electrodes 5 and the backing plate 21.

The black matrix 23 separates and isolates the color filter photoresist 22 and the photo spacer 24 is arranged on the black matrix 23.

Step 5: referring to FIG. 2, coating an alignment solution on the color filter photoresist 22, the black matrix 23, and the photo spacer 24 to form an alignment film 25, thereby forming a CF substrate 2.

Step 6: referring to FIG. 2, providing a TFT array substrate 1 and laminating the TFT array substrate 1 and the CF substrate 2 together in such a way that the touch receiving electrodes 5 face the TFT array substrate 1 and filling liquid crystal between the TFT array substrate 1 and the CF substrate 2 to form a liquid crystal layer 3.

The structure and the manufacturing method of the TFT array substrate 1 are similar to those of the prior art and thus no detail will be provided herein.

The above-described manufacturing method of an IPS in-cell touch display panel applies a grey-tone mask and etching operation to form touch transmission electrodes 4 and preserve portions of an organic photoresist that correspond to intersections in perpendicularity between the touch transmission electrodes 4 and touch receiving electrodes 5 to form insulating photoresist blocks 6 to allow insulation to be achieved between the touch transmission electrodes 4 and the touch receiving electrodes 5 with the insulating photoresist blocks 6 so that coating and masking and etching operations specifically for making an insulation layer can be eliminated to thereby simplify the manufacturing operation of a touch display panel, reduce the manufacturing cost, and increase the manufacturing efficiency; and in addition, the touch transmission electrodes 4 and the touch receiving electrodes 5 provide an effect of electromagnetic shielding to capacitance of the liquid crystal layer 3 so that there is no need to specifically forma protection electrode on a surface of the CF substrate 2 that is distant from the liquid crystal layer 3 to thereby further simplify the manufacturing operation of the touch display panel, reduce the manufacturing cost, and increase the manufacturing efficiency.

In summary, the present invention provides an IPS in-cell touch display panel, which comprises insulating photoresist blocks arranged at the intersections of touch transmission electrodes and touch receiving electrodes to separate the two from each other for insulation so that the manufacturing operation is simplified, the manufacturing cost is reduced, and the manufacturing efficiency is increased. Further, the touch transmission electrodes and the touch receiving electrodes provide an effect of electromagnetic shielding for capacitance of a liquid crystal layer. The present invention also provides a manufacturing method of an IPS in-cell touch display panel that applies a grey-tone mask and etching operation to form touch transmission electrodes and preserves portions of an organic photoresist that correspond to intersections in perpendicularity between the touch transmission electrodes and touch receiving electrodes to form insulating photoresist blocks to allow insulation to be achieved between the touch transmission electrodes and the touch receiving electrodes with the insulating photoresist blocks so that coating and masking and etching operations specifically for making an insulation layer can be eliminated to thereby simplify the manufacturing operation of a touch display panel, reduce the manufacturing cost, and increase the manufacturing efficiency; and in addition, the touch transmission electrodes and the touch receiving electrodes provide an effect of electromagnetic shielding to capacitance of the liquid crystal layer so that there is no need to specifically form a protection electrode on a surface of the CF substrate that is distant from the liquid crystal layer to thereby further simplify the manufacturing operation of the touch display panel, reduce the manufacturing cost, and increase the manufacturing efficiency.

Based on the description given above, those having ordinary skills of the art may easily contemplate various changes and modifications of the technical solution and technical ideas of the present invention and all these changes and modifications are considered within the protection scope of right for the present invention.

What is claimed is:

1. An in-plane switching (IPS) in-cell touch display panel, comprising a thin-film transistor (TFT) array substrate, a color filter (CF) substrate opposite to the TFT array substrate, a liquid crystal layer interposed between the TFT array substrate and the CF substrate, a plurality of touch transmission electrodes parallel to each other and arranged on a surface of the CF substrate that is adjacent to the liquid crystal layer, and a plurality of touch receiving electrodes parallel to each other and perpendicularly intersecting the touch transmission electrodes in space, insulation being achieved by a plurality of insulating photoresist blocks arranged at locations respectively corresponding to the intersections of the touch transmission electrodes and the touch receiving electrodes to separate the two from each other;
the CF substrate comprising a backing plate, the plurality of touch transmission electrodes being arranged on a surface of the backing plate that is adjacent to the liquid crystal layer, the plurality of touch receiving electrodes being arranged to perpendicularly intersect the touch transmission electrodes in space through the insulating photoresist blocks therebetween.

2. The IPS in-cell touch display panel as claimed in claim 1, wherein the touch transmission electrodes and the touch receiving electrodes are formed of a material of indium tin oxide (ITO).

3. The IPS in-cell touch display panel as claimed in claim 2, wherein the touch transmission electrodes and the touch receiving electrodes have a thickness of 400-1000 Å.

4. The IPS in-cell touch display panel as claimed in claim 1, wherein the CF substrate further comprises a color filter photoresist arranged on the plurality of touch receiving electrodes and the backing plate, a black matrix separating and isolating the color filter photoresist, a photo spacer arranged on the black matrix, and an alignment film covering the color filter photoresist, the black matrix, and the photo spacer.

5. An in-plane switching (IPS) in-cell touch display panel, comprising a thin-film transistor (TFT) array substrate, a color filter (CF) substrate opposite to the TFT array substrate, a liquid crystal layer interposed between the TFT array substrate and the CF substrate, a plurality of touch transmission electrodes parallel to each other and arranged on a surface of the CF substrate that is adjacent to the liquid crystal layer, and a plurality of touch receiving electrodes parallel to each other and perpendicularly intersecting the touch transmission electrodes in space, insulation being achieved by a plurality of insulating photoresist blocks arranged at locations respectively corresponding to the intersections of the touch transmission electrodes and the touch receiving electrodes to separate the two from each other;
the CF substrate comprising a backing plate, the plurality of touch transmission electrodes being arranged on a surface of the backing plate that is adjacent to the liquid crystal layer, the plurality of touch receiving electrodes being arranged to perpendicularly intersect the touch transmission electrodes in space through the insulating photoresist blocks therebetween;
wherein the touch transmission electrodes and the touch receiving electrodes are formed of a material of indium tin oxide (ITO);
wherein the touch transmission electrodes and the touch receiving electrodes have a thickness of 400-1000 Å; and
wherein the CF substrate further comprises a color filter photoresist arranged on the plurality of touch receiving electrodes and the backing plate, a black matrix separating and isolating the color filter photoresist, a photo spacer arranged on the black matrix, and an alignment film covering the color filter photoresist, the black matrix, and the photo spacer.

6. A manufacturing method of an in-plane switching (IPS) in-cell touch display panel, comprising the following steps:
(1) providing a backing plate, coating a transparent conductive layer on a surface of the backing plate, applying a grey-tone mask and etching operation to form a plurality of touch transmission electrodes parallel to each other and a plurality of independent insulating photoresist blocks on each of the touch transmission electrodes;
(2) subjecting the touch transmission electrodes to high temperature annealing;
(3) further coating a transparent conductive layer and applying a regular masking and etching operation to form a plurality of touch receiving electrodes that perpendicularly intersects the touch transmission electrodes in space through the insulating photoresist blocks;
(4) applying a regular masking and etching operation to form, in sequence, a black matrix, a color filter photoresist, and a photo spacer on the touch receiving electrodes and the backing plate, wherein the black matrix separates and isolates the color filter photoresist, and the photo spacer is arranged on the black matrix;
(5) coating an alignment solution on the color filter photoresist, the black matrix, and the photo spacer to form an alignment film, thereby forming a color filter (CF) substrate; and
(6) providing a thin-film transistor (TFT) array substrate and laminating the TFT array substrate and the CF substrate together in such a way that the touch receiving electrodes face the TFT array substrate, and filling liquid crystal between the TFT array substrate and the CF substrate to form a liquid crystal layer.

7. The manufacturing method of the IPS in-cell touch display panel as claimed in claim 6, wherein step (1) comprises:
(11) coating a layer of organic photoresist on the transparent conductive layer;
(12) applying a grey-tone mask to subject an area of the organic photoresist corresponding to a spatial interval between every two adjacent ones of the touch transmission electrodes to full exposure and an area of the organic photoresist corresponding to each of the insulating photoresist blocks not subjected to exposure; and subjecting an area of the organic photoresist corresponding a location of each of the touch transmission electrodes between every two adjacent ones of the insulating photoresist blocks to partial exposure; and then conducting development;
(13) subjecting the transparent conductive layer to etching with the organic photoresist as a shielding layer to form a plurality of touch transmission electrodes parallel to each other; and
(14) subjecting the organic photoresist to ashing treatment to remove the partial exposure portions of the organic photoresist with unexposed portions of the organic photoresist left, so as to form a plurality of independent insulating photoresist blocks on each of the touch transmission electrodes.

8. The manufacturing method of the IPS in-cell touch display panel as claimed in claim 7, wherein in step (11), the transparent conductive layer is formed of a material of indium tin oxide (ITO) and has a thickness of 400-1000 Å and the organic photoresist has a thickness of 4000-20000 Å.

9. The manufacturing method of the IPS in-cell touch display panel as claimed in claim 6, wherein in step (3), the transparent conductive layer is formed of a material of ITO and has a thickness of 400-1000 Å.

10. The manufacturing method of the IPS in-cell touch display panel as claimed in claim 6, wherein in step (2), an atmosphere for the high temperature annealing is nitrogen or dry air, a temperature of the high temperature annealing being 250° C., a period of time for the annealing being 30 minutes.

11. The manufacturing method of the IPS in-cell touch display panel as claimed in claim 6, wherein the backing plate is a glass plate.
